(19) United States
(12) Patent Application Publication
(10) Pub. No.: US 2009/0188536 A1
(43) Pub. Date: Jul. 30, 2009

(54) Ultrasonic cleaning device

(75) Inventor: Tzu Lung Ho, Changhua Hsien (TW)

Correspondence Address: CHARLES E. BAXLEY, ESQUIRE, 90 JOHN STREET, SUITE 309, NEW YORK, NY, 10038, US

(73) Assignee: Taiwan Supercritical Technology Co., Ltd.

(21) Appl. No.: 12/012,190

(22) Filed: Jan. 30, 2008

(51) Int. Cl. B08B 3/12

(52) U.S. Cl. 134/184

(57) ABSTRACT

An ultrasonic cleaning device includes a liquid tank having a chamber for receiving a liquid and a work piece and having an opening formed in a bottom board for attaching an ultrasonic transducer with an insert, and for allowing the ultrasonic waves or energy generated by the ultrasonic transducer to be effectively applied to the liquid and the work piece received in the liquid tank. The insert includes an outer thread formed on a downwardly extended shank, and the ultrasonic transducer includes a peripheral fence having an inner thread for engaging with the outer thread of the insert and for solidly securing the ultrasonic transducer to the bottom board of the liquid tank.

### BACKGROUND OF THE INVENTION

1. Field of the Invention

The present invention relates to an ultrasonic cleaning device, and more particularly to an ultrasonic cleaning device including an ultrasonic transducer attaching structure for suitably attaching or engaging the ultrasonic transducer to the liquid tank and for suitably generating or applying the ultrasonic waves or energy to the liquid received in the liquid tank.

2. Description of the Prior Art

Typical ultrasonic cleaning devices comprise a transducer means directed toward the work piece for generating or applying the ultrasonic waves or energy to the work piece and for cleaning the work piece.

For example, U.S. Pat. No. 4,178,188 to Dussault et al. discloses one of the typical methods for cleaning workpieces with the ultrasonic energy and also comprising a transducer means directed toward the workpieces for generating or applying the ultrasonic waves or energy to work onto the work piece or to clean the workpieces.

However, the transducer means is spaced away from the workpieces and may not effectively apply the ultrasonic energy to the workpieces, and may not be used to generate or apply the ultrasonic waves or energy to the liquid received in a cleaning or liquid tank.

U.S. Pat. No. 4,409,999 to Pedziwiatr discloses another typical automatic ultrasonic cleaning apparatus comprising a number of transducers or ultrasonic energy generators attached to the bottom of a cleaning or liquid tank for generating or applying the ultrasonic waves or energy to the liquid received in the cleaning or liquid tank.

However, the transducers or ultrasonic energy generators are normally attached or secured to the bottom of the cleaning or liquid tank with adhesive materials which may reduce the ultrasonic waves or energy generating effect.

U.S. Pat. No. 4,870,982 to Liu discloses a further typical ultrasonic cleaning apparatus comprising a transducer attached to the bottom of a cleaning or liquid tank with a layer of epoxy glue. However, similarly, the layer of epoxy glue may also reduce the ultrasonic waves or energy generating effect.

U.S. Pat. No. 5,119,840 to Shibata discloses a still further typical ultrasonic oscillating apparatus comprising a transducer attached to the bottom of a cleaning or liquid tank with an adhesive. However, similarly, the layer of adhesive may also reduce the ultrasonic waves or energy generating effect, and the transducer may be easily disengaged from the bottom of the cleaning or liquid tank.

U.S. Pat. No. 5,722,444 to Prokopenko et al. discloses a still further typical rigid ultrasonic radiation plate assembly system for ultrasonic cleaning tanks and comprising a radiating rigid plate with a number of studs welded or secured to the bottom of the radiating rigid plate, and the studs are extended through the bottom of the cleaning or liquid tank.

However, the liquid received in the cleaning or liquid tank may have a good chance to flow out of the cleaning or liquid tank due to the extension of the welded studs through the bottom of the cleaning or liquid tank.

The present invention has arisen to mitigate and/or obviate the afore-described disadvantages of the conventional ultrasonic cleaning devices.

### SUMMARY OF THE INVENTION

The primary objective of the present invention is to provide an ultrasonic cleaning device including an ultrasonic cleaning device including an ultrasonic transducer attaching structure for suitably attaching or engaging the ultrasonic transducer to the liquid tank and for suitably generating or applying the ultrasonic waves or energy to the liquid received in the liquid tank.

In accordance with one aspect of the invention, there is provided an ultrasonic cleaning device comprising a liquid tank including a chamber formed therein for receiving a liquid and a work piece to be cleaned with an ultrasonic energy, and including a bottom board, and including an opening formed in the bottom board, an ultrasonic transducer engaged with the bottom board of the liquid tank, and an insert engaged through the opening of the bottom board and engaged with the ultrasonic transducer for detachably securing the ultrasonic transducer to the bottom board of the liquid tank and for allowing the ultrasonic waves or energy generated by the ultrasonic transducer to be effectively applied to the liquid and the work pieces received in the liquid tank.

The insert includes a peripheral flange extended radially and outwardly therefrom for engaging with the bottom board and for anchoring the insert to the bottom board. The liquid tank includes a sealing ring engaged between the bottom board and the peripheral flange of the insert. The liquid tank includes an inner peripheral shoulder formed in the bottom board and located around the opening of the bottom board for receiving the sealing ring.

The insert includes a shank extended downwardly therefrom for engaging through the opening of the bottom board and for engaging with the ultrasonic transducer. The ultrasonic transducer includes a compartment formed therein for receiving the shank and for engaging with the shank.

The ultrasonic transducer includes a peripheral fence extended upwardly therefrom for forming the compartment thereof, and includes an inner thread formed in the peripheral fence, and the insert includes an outer thread formed on the shank for engaging with the inner thread of the peripheral fence and for detachably securing the ultrasonic transducer to the bottom board of the liquid tank. The liquid tank includes a sealing ring engaged between the bottom board and the peripheral fence of the ultrasonic transducer for making a water tight seal between the bottom board and the ultrasonic transducer.

The ultrasonic transducer includes a screw hole formed in a bottom portion thereof for engaging with a fastener. The ultrasonic transducer includes two conductors secured to the fastener with two spacers and a lock nut.

The ultrasonic transducer includes an outer thread, and the liquid tank includes an inner thread formed therein for engaging with the outer thread of the ultrasonic transducer and for detachably securing the ultrasonic transducer to the bottom board of the liquid tank.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a ultrasonic cleaning device in accordance with the present invention;

FIG. 2 is a partial cross sectional view of the ultrasonic cleaning device;

FIG. 3 is a cross sectional view illustrating the operation of the ultrasonic cleaning device;

FIG. 4 is an exploded view similar to FIG. 1, illustrating the other arrangement of the ultrasonic cleaning device; and

FIG. 5 is a partial cross sectional view of the ultrasonic cleaning device as shown in FIG. 4.

### DETAILED DESCRIPTION OF THE PREFERRED EMBODIMENT

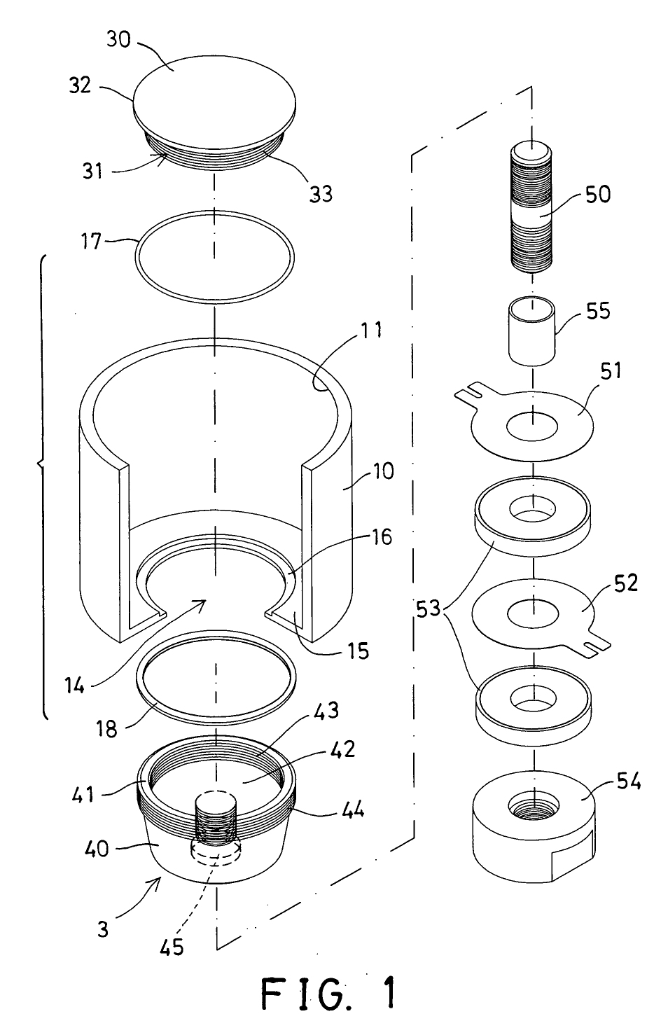

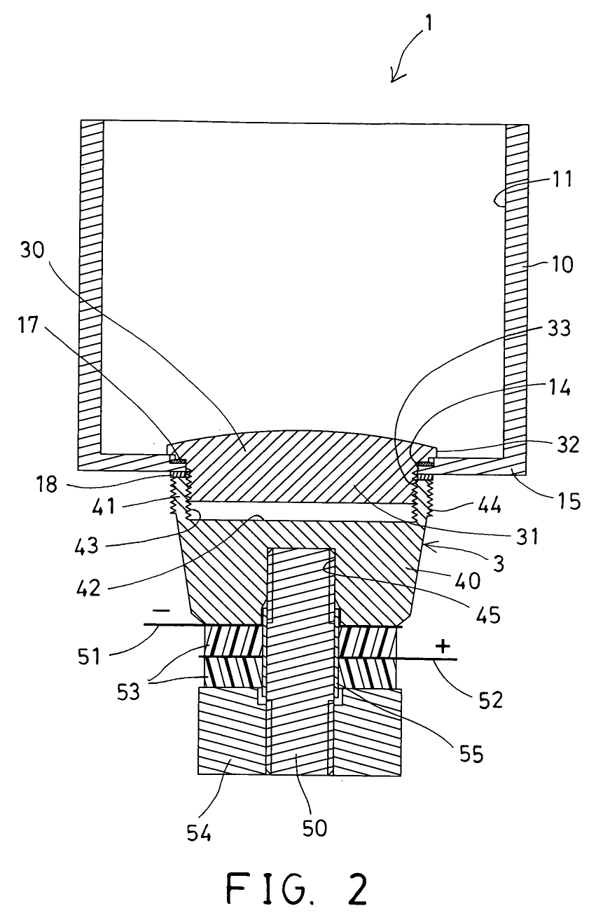

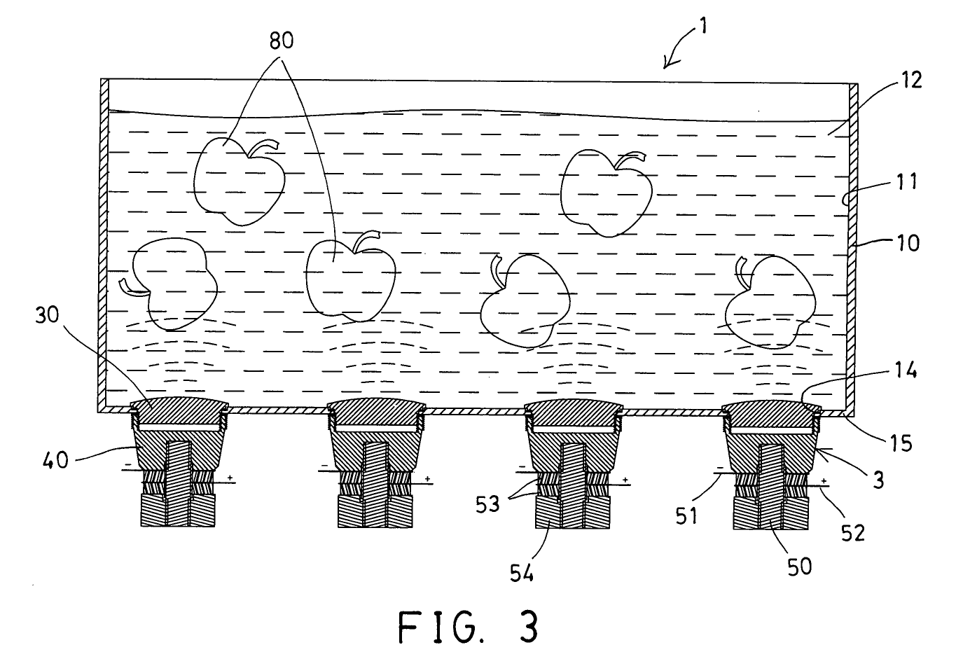

Referring to the drawings, and initially to FIGS. 1-2, an ultrasonic cleaning device 1 in accordance with the present invention comprises a cleaning or liquid tank 10 including a chamber 11 formed therein for receiving a fluid or liquid 12 and the work pieces 80 (FIG. 3) to be cleaned with the ultrasonic energy, and including one (FIGS. 1, 2) or more (FIG. 3) openings 14 formed in the bottom portion or the bottom board 15 thereof for receiving or attaching the ultrasonic energy generating means or device 3, and including one or more inner peripheral recesses or shoulders 16 formed in the bottom board 15 and located around the openings 14 of the bottom board 15 respectively and communicating with the openings 14 of the bottom board 15 respectively.

A sealing ring 17 is received or attached in the inner peripheral shoulder 16 of the bottom board 15, and another sealing ring 18 is attached to the bottom portion of the bottom board 15 and located around the opening 14 of the bottom board 15. The ultrasonic energy generating means or device 3 includes a fastener or insert 30 having a shank 31 extended downwardly therefrom for engaging through the opening 14 of the bottom board 15, and having a peripheral flange 32 extended radially and outwardly from the upper portion of the shank 31 for engaging with the bottom board 15 or the sealing ring 17 and for stably anchoring or securing the sealing ring 17 between the bottom board 15 and the peripheral flange 32 of the insert 30, and having an outer thread 33 formed on the outer peripheral portion of the shank 31.

The ultrasonic energy generating means or device 3 further includes an ultrasonic generator and/or ultrasonic transducer 40 having a peripheral fence 41 extended upwardly therefrom for engaging with the bottom board 15 of the liquid tank 10 and for forming or defining a compartment 42 therein which faces toward or aligned with the opening 14 of the bottom board 15, and having an inner thread 43 formed in the peripheral fence 41 for threading or for engaging with the outer thread 33 of the shank 31 or of the insert 30 and for detachably securing the ultrasonic transducer 40 to the bottom board 15 of the liquid tank 10, in which the shank 31 of the insert 30 is engageable into the compartment 42 of the ultrasonic transducer 40, and the peripheral fence 41 of the ultrasonic transducer 40 is engageable with the sealing ring 18 for stably attaching or anchoring or securing the sealing ring 18 between the bottom board 15 and the peripheral fence 41 of the ultrasonic transducer 40.

The ultrasonic transducer 40 may further include an outer thread 44 formed on the outer peripheral portion of the ultrasonic transducer 40, and may further include an outer thread or a screw hole 45 formed in the bottom portion thereof for threading or for engaging with a fastener 50 and for detachably securing the fastener 50 to the ultrasonic transducer 40. Two conductors 51, 52 may be attached or secured onto the fastener 50 with one or more (such as two) spacers 53 and a lock nut 54, and/or a barrel 55 for electrically coupling the ultrasonic transducer 40 to the electric power source (not shown) and for allowing the ultrasonic transducer 40 to generate or to effectively apply the ultrasonic waves or energy to the liquid 12 and the work pieces 80 received in the liquid tank 10 (FIG. 3).

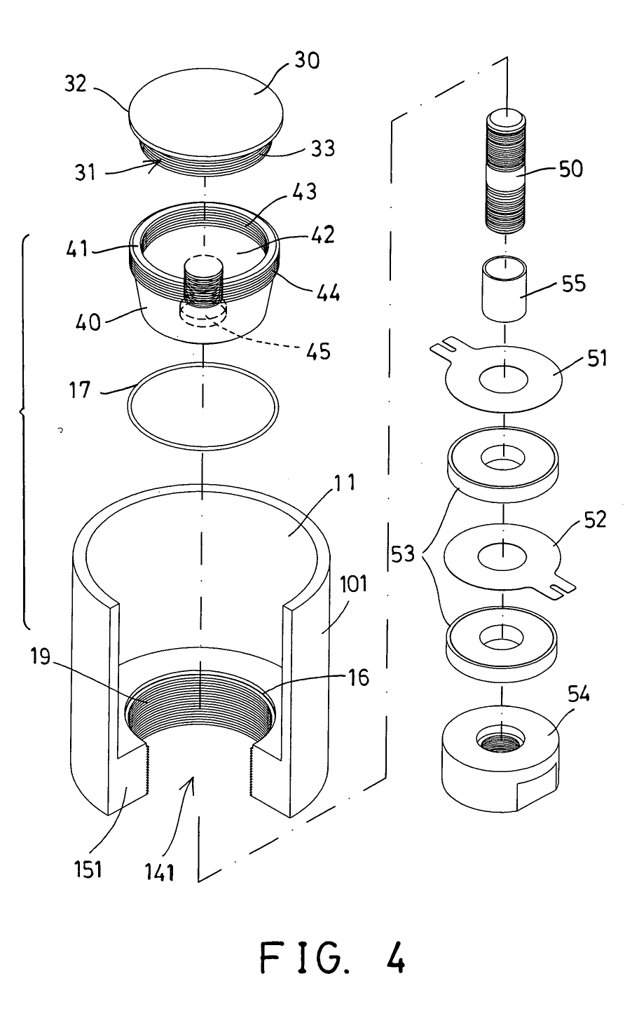

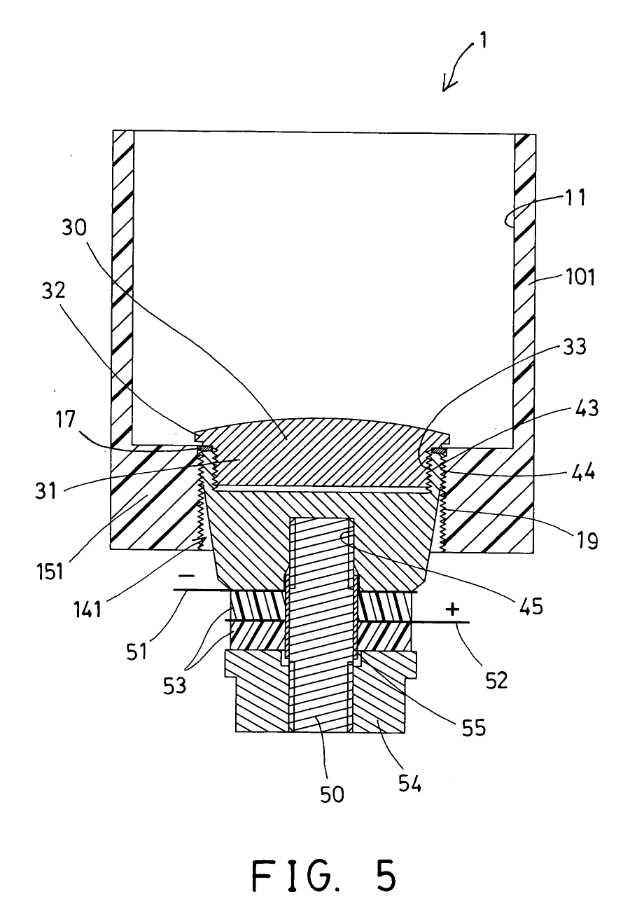

Alternatively, as shown in FIGS. 4 and 5, the opening 141 in the bottom portion or the bottom board 151 of the liquid tank 101 may also include an inner peripheral shoulder 16 formed in the bottom board 151 and located around the opening 141 of the bottom board 151 for engaging with the sealing ring 17 which may also be engaged with the peripheral flange 32 of the insert 30 and which may also be engaged with the peripheral fence 41 of the ultrasonic transducer 40 for detachably securing the ultrasonic transducer 40 to the bottom board 151 of the liquid tank 101, in which the opening 141 of the bottom board 151 of the liquid tank 101 may include an increased depth or thickness, and the liquid tank 101 may include an inner thread 19 formed therein for threading or for engaging with the outer thread 44 of the ultrasonic transducer 40 and for further detachably and solidly securing the ultrasonic transducer 40 to the bottom board 151 of the liquid tank 10.

In operation, as shown in FIG. 3, the ultrasonic waves or energy generated by the ultrasonic transducer 40 may be effectively transmitted through the opening 14 of the bottom board 15 of the liquid tank 10 and may be effectively transmitted and applied to the liquid 12 and the work pieces 80 received in the liquid tank 10 in order to suitably or effectively clean the work pieces 80. In addition, the ultrasonic transducer 40 may be solidly secured to the bottom board 15 of the liquid tank 10 with the insert 30 and will not be disengaged from the bottom board 15 of the liquid tank 10.

Accordingly, the ultrasonic cleaning device in accordance with the present invention includes an ultrasonic cleaning device including an ultrasonic transducer attaching structure for suitably attaching or engaging the ultrasonic transducer to the liquid tank and for suitably generating or applying the ultrasonic waves or energy to the liquid received in the liquid tank.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An ultrasonic cleaning device comprising:
a liquid tank including a chamber formed therein for receiving a liquid and a work piece to be cleaned with an ultrasonic energy, and including a bottom board, and including an opening formed in said bottom board,
an ultrasonic transducer engaged with said bottom board of said liquid tank, and
an insert engaged through said opening of said bottom board and engaged with said ultrasonic transducer for detachably securing said ultrasonic transducer to said bottom board of said liquid tank.

2. The ultrasonic cleaning device as claimed in claim 1, wherein said insert includes a peripheral flange extended radially and outwardly therefrom for engaging with said bottom board.

3. The ultrasonic cleaning device as claimed in claim 2, wherein said liquid tank includes a sealing ring engaged between said bottom board and said peripheral flange of said insert.

4. The ultrasonic cleaning device as claimed in claim 3, wherein said liquid tank includes an inner peripheral shoulder formed in said bottom board and located around said opening of said bottom board for receiving said sealing ring.

5. The ultrasonic cleaning device as claimed in claim 1, wherein said insert includes a shank extended downwardly therefrom for engaging through said opening of said bottom board and for engaging with said ultrasonic transducer.

6. The ultrasonic cleaning device as claimed in claim 5, wherein said ultrasonic transducer includes a compartment formed therein for receiving said shank.

7. The ultrasonic cleaning device as claimed in claim 6, wherein said ultrasonic transducer includes a peripheral fence extended upwardly therefrom for forming said compartment thereof, and includes an inner thread formed in said peripheral fence, and said insert includes an outer thread formed on said shank for engaging with said inner thread of said peripheral fence and for detachably securing said ultrasonic transducer to said bottom board of said liquid tank.

8. The ultrasonic cleaning device as claimed in claim 7, wherein said liquid tank includes a sealing ring engaged between said bottom board and said peripheral fence of said ultrasonic transducer.

9. The ultrasonic cleaning device as claimed in claim 1, wherein said ultrasonic transducer includes a screw hole formed in a bottom portion thereof for engaging with a fastener.

10. The ultrasonic cleaning device as claimed in claim 9, wherein said ultrasonic transducer includes two conductors secured to said fastener with two spacers and a lock nut.

11. The ultrasonic cleaning device as claimed in claim 1, wherein said ultrasonic transducer includes an outer thread, and said liquid tank includes an inner thread formed therein for engaging with said outer thread of said ultrasonic transducer and for detachably securing said ultrasonic transducer to said bottom board of said liquid tank.
